(19) United States
(12) Patent Application Publication
(10) Pub. No.: US 2026/0059321 A1
(43) Pub. Date: Feb. 26, 2026

(54) SYSTEMS AND METHODS FOR PROVIDING PAGING PRIORITY FOR USER EQUIPMENT ASSOCIATED WITH NON-THIRD-GENERATION-PARTNERSHIP-PROJECT ACCESS NETWORK

(71) Applicant: Verizon Patent and Licensing Inc., Basking Ridge, NJ (US)

(72) Inventors: Toby Varughese JOHN, Murphy, TX (US); Chien-Yuan HUANG, Basking Ridge, NJ (US); Bibi M. HAKIMZADEH, Fort Worth, TX (US); Shanthala KURAVANGI-THAMMAIAH, Keller, TX (US)

(73) Assignee: Verizon Patent and Licensing Inc., Basking Ridge, NJ (US)

(21) Appl. No.: 18/809,713

(22) Filed: Aug. 20, 2024

(51) Int. Cl. H04W 12/50; H04W 68/02; H04W 76/12

(52) U.S. Cl. CPC H04W 12/50; H04W 68/02; H04W 76/12

(57) ABSTRACT

A non-3GPP access network device may establish a secure tunnel for a first UE, and may detect congestion. The non-3GPP access network device may detect a period of inactivity associated with the first UE, and may transition the secure tunnel to an idle state based on detecting the period of inactivity. The non-3GPP access network device may receive a paging message that includes a paging priority indicator, and may identify a critical service priority for the first UE based on the paging priority indicator. The non-3GPP access network device may provide the paging message to the first UE, and may receive, from the first UE, a request to establish a communication with a second UE. The non-3GPP access network device may transition the secure tunnel to an active state based on the request, and may enable the communication between the first UE and the second UE via the secure tunnel.

### BACKGROUND

The progressively increasing demands on non-Third-Generation-Partnership-Project (non-3GPP) access networks, such as Wi-Fi, pose significant challenges for managing network resources efficiently. In particular, maintaining continuous connections between a user equipment (UE) and non-3GPP access networks involves providing constant and secure tunnels (e.g., Internet Protocol Security (IPSec) tunnels) and sessions, which persist even without active data exchange.

### BRIEF DESCRIPTION OF THE DRAWINGS

FIGS. 1A-1C are diagrams of an example associated with providing paging priority for a UE associated with a non-3GPP access network.

FIG. 2 is a diagram of an example environment in which systems and/or methods described herein may be implemented.

FIG. 3 is a diagram of example components of one or more devices of FIG. 2.

FIG. 4 is a flowchart of an example process for providing paging priority for a UE associated with a non-3GPP access network.

### DETAILED DESCRIPTION OF EXAMPLE EMBODIMENTS

The following detailed description of example implementations refers to the accompanying drawings. The same reference numbers in different drawings may identify the same or similar elements.

As the proliferation of Wi-Fi endpoints in the market continues, the inefficiency of non-3GPP access networks becomes increasingly costly, placing a strain on network resources of the non-3GPP access networks as well as corresponding core networks. In the event of congestion in a non-3GPP access network, prioritizing critical services (e.g., a multimedia priority service (MPS), a mission-critical service (MCS), and/or the like) becomes even more difficult. The challenge lies in ensuring that these critical services are maintained reliably despite the congested state of the non-3GPP access network and without sacrificing security. Thus, current techniques for handling priority services in non-3GPP access networks consume computing resources (e.g., processing resources, memory resources, communication resources, and/or the like), networking resources, and/or other resources associated with failing to provide critical services when the non-3GPP access network is congested, handling data breaches associated with incorrectly providing critical services when the non-3GPP access is congested, unnecessarily maintaining continuous connections between UEs and the non-3GPP access networks, and/or the like.

Some implementations described herein relate to a non-3GPP access network device (e.g., an access point) that provides paging priority for a UE associated with a non-3GPP access network. For example, the non-3GPP access network device may establish a secure tunnel for a first UE, and may detect congestion associated with a non-3GPP access network provided by the non-3GPP access network device. The non-3GPP access network device may detect a period of inactivity associated with the first UE, and may transition the secure tunnel to an idle state based on detecting the period of inactivity associated with the first UE. The non-3GPP access network device may receive, from a core network, a paging message that includes a paging priority indicator, and may identify a critical service priority for the first UE based on the paging priority indicator included in the paging message. The non-3GPP access network device may provide the paging message to the first UE, and may receive, from the first UE, a request to establish a communication with a second UE. The non-3GPP access network device may transition the secure tunnel from the idle state to an active state based on the request (e.g., by reestablishing necessary security associations based on the request, reconfiguring tunnel parameters, and activating the tunnel to enable secure communication), and may enable the communication between the first UE and the second UE via the secure tunnel in the active state.

In this way, a non-3GPP access network device provides paging priority for a UE associated with a non-3GPP access network. For example, the non-3GPP access network device may intelligently transition a secure tunnel to an idle state in response to detected inactivity from a UE. By transitioning the secure tunnel to the idle state after a period of UE inactivity, the non-3GPP access network device may prevent maintaining active but unnecessary connections. The non-3GPP access network device may process a paging message with a priority indicator, and may identify a critical service priority for the UE based on the priority indicator. Upon request from the UE, the non-3GPP access network device may promptly transition the secure tunnel from the idle state to an active state to enable communications for the UE. Thus, the non-3GPP access network device may conserve computing resources, networking resources, and/or other resources that would have otherwise been consumed by failing to provide critical services when the non-3GPP access network is congested, handling data breaches associated with incorrectly providing critical services when the non-3GPP access is congested, unnecessarily maintaining continuous connections between UEs and the non-3GPP access networks, and/or the like.

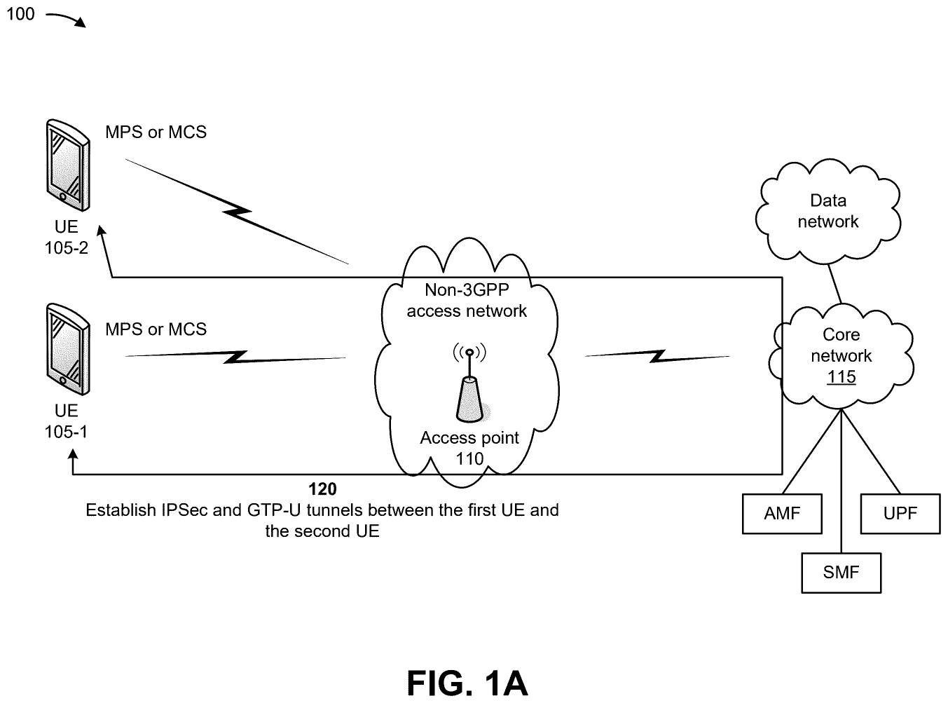

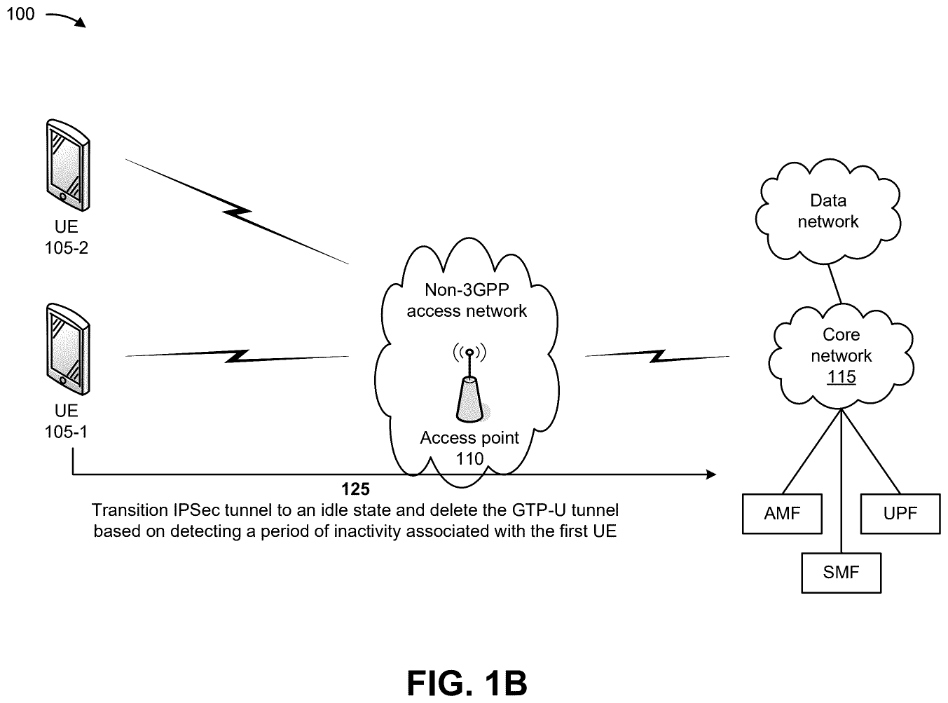

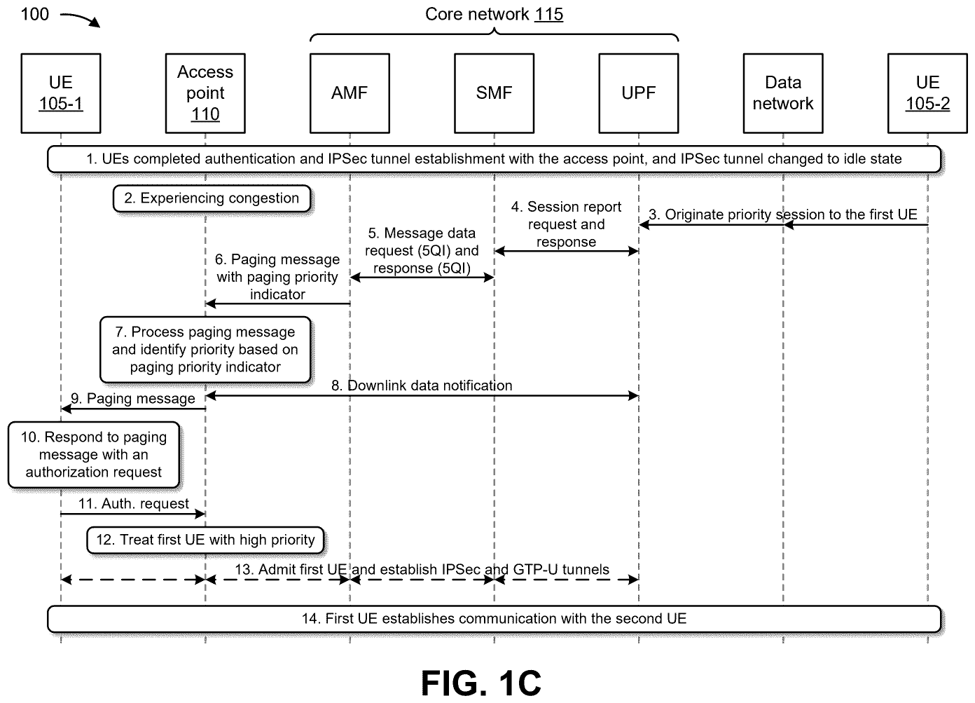

FIGS. 1A-1C are diagrams of an example 100 associated with providing paging priority for a UE associated with a non-3GPP access network. As shown in FIGS. 1A-1C, example 100 includes a first UE 105-1, a second UE 105-2, an access point 110 providing a non-3GPP access network, a data network, and a core network 115 that includes an access and mobility management function (AMF), a session management function (SMF), and a user plane function (UPF). As further shown in FIG. 1A, the UEs 105 may be associated with a high priority service, such as an MPS, MCS (e.g., a public safety service), a high priority enterprise service, and/or the like. Further details of the UEs 105, the access point 110, the non-3GPP access network, the data network, the core network 115, the AMF, the SMF, and the UPF are provided elsewhere herein.

As shown in FIG. 1A, and be reference number 120, an IPSec tunnel and a general packet radio service (GPRS) tunnelling protocol in user plane (GTP-U) tunnel may be established between the first UE 105-1 and the second 105-2, via the access point 110, the core network 115, and the data network. For example, the first UE 105-1 and the second 105-2 may be authenticated for utilizing the non-3GPP access network, the core network 115, and the data network for communications. The IPSec tunnel the GTP-U tunnel may be established between the first UE 105-1 and the second UE 105-2 after the first UE 105-1 and the second UE 105-2 have been authenticated. Establishing an IPSec tunnel and a GTP-U tunnel between the first UE 105-1 and the second 105-2 may be particularly useful for handling critical services, such as multimedia MPS or MCS, which require reliable and secure data transmission to ensure essential public safety communication.

An IPSec tunnel may ensure secure and private communications between the first UE 105-1 and the second UE 105-2 by establishing encrypted and authenticated connections.

Establishing an IPSec tunnel may include a first Internet key exchange (IKE) phase and a second IKE phase. In the first IKE phase, a secure, authenticated channel may be created between the first UE 105-1 and the second UE 105-2. The first UE 105-1 and the second UE 105-2 may negotiate and utilize an encryption technique, a hash technique, a group for generating public and private keys, and an authentication method. This phase results in the creation of a secure and authenticated channel called an IKE security association (SA). In the second IKE phase, the first UE 105-1 and the second UE 105-2 may negotiate IPSec SAs for actual data encryption and authentication. Once the IPSec SAs are in place, the IPSec tunnel may be established between the first UE 105-1 and the second UE 105-2. In some implementations, a secure sockets layer (SSL) tunnel or a transport layer security (TLS) tunnel may be established as alternatives for secure communication between the first UE 105-1 and the second UE 105-2.

The GTP-U tunnel may be utilized for transporting user data (e.g., between the first UE 105-1 and the second UE 105-2) within the core network 115. To establish the GTP-U tunnel, the first UE 105-1 may provide, to the core network 115, a session establishment request to establish a packet data network (PDN) connection. The core network 115 may process the session establishment request, and may generate a response to the session establishment request that includes information for creating the GTP-U tunnel (e.g., tunnel endpoint identifiers, addresses for network devices of the core network 115, and/or the like). The core network 115 may provide the response to the first UE 105-1, and the first UE 105-1 may utilize the information in the response to securely provide data to the second UE 105-2 via the GTP-U tunnel. The GTP-U tunnel may ensure that user data can be transmitted efficiently between the first UE 105-1 and the Internet or other packet data networks, encapsulating user data packets in GTP-U headers and sending the user data packets through the core network 115 to the second UE 105-2. Additionally, or alternatively, establishing the GTP-U tunnel may include implementing multiprotocol label switching (MPLS) for enhanced data routing and encapsulation.

As shown in FIG. 1B, and by reference number 125, the access point 110 may transition the IPSec tunnel to an idle state and may delete the GTP-U tunnel based on detecting a period of inactivity associated with the first UE 105-1. For example, the access point 110 may monitor bearer activity of the first UE 105-1, and may determine (e.g., with timers) the period of inactivity for the first UE 105-1 based on monitoring the absence of activity from the first UE 105-1 for a time period that exceeds a threshold time period (e.g., in minutes, hours, and/or the like). The threshold time period for inactivity may be configurable, allowing for adaptation to various network conditions and usage patterns, and/or may be dynamically adjusted, based on real-time network load, to optimize network performance. In some implementations, the access point 110 may detect the period of inactivity associated with the first UE 105-1 using a variety of inactivity detection methods beyond timers and bearer activity monitoring. For example, the access point 110 may analyze data packet intervals or may utilize machine learning models to predict the period of inactivity. These advanced detection methods may enable more accurate predictions periods of inactivity and may minimize a quantity of false positives (e.g., where the first UE 105-1 is mistakenly assumed to be inactive).

After detecting the period of inactivity associated with the first UE 105-1, the access point 110 may transition the IPSec tunnel to the idle state and may delete the GTP-U tunnel. After detecting the period of inactivity associated with the first UE 105-1, the access point 110 may also notify the core network 115 and/or the data network about the period of inactivity (e.g., inactive or idle state) of the first UE 105-1. In some implementations, after transitioning the IPSec tunnel to the idle state, the access point 110 may store context information (e.g., parameters) associated with the IPSec tunnel for future reference (e.g., facilitating transition of the IPSec tunnel to an active state when activity resumes for the first UE 105-1).

Additionally, or alternatively, the access point 110 may utilize a staggered approach to transitioning the IPSec tunnel to an idle state, where specific criteria are gradually met rather than a single threshold determining the transition. Additionally, or alternatively, in certain scenarios, the access point 110 may only partially delete the GTP-U tunnel, maintaining key elements that allow for rapid reactivation when activity resumes for the first UE 105-1. This may ensure that the first UE 105-1 experiences minimal delays when reactivating the GTP-U tunnel. In some implementations, the access point 110 may utilize a downlink data notification to notify the core network 115 about transitioning the IPSec tunnel to the idle state.

FIG. 1C depicts an example information flow diagram associated with providing paging priority for a UE 105 associated with a non-3GPP access network. As shown at step 1 of the FIG. 1C, the first UE 105-1 and the second UE 105-2 may complete authentication, the access point 110 may establish an IPSec tunnel between the first UE 105-1 and the second UE 105-2, and the access point 110 may change the IPSec tunnel to an idle state after a period of inactivity by the first UE 105-1. For example, the first UE 105-1 and the second UE 105-2 may complete authentication and the access point 110 may establish the IPSec tunnel between the first UE 105-1 and the second UE 105-2, as described above in connection with FIG. 1A. The access point 110 may also establish a GTP-U tunnel between the first UE 105-1 and the second UE 105-2, as further described above in connection with FIG. 1A. The first UE 105-1 or the access point 110 may monitor bearer activity of the first UE 105-1, and may determine (e.g., with timers) the period of inactivity for the first UE 105-1 based on monitoring the absence of activity from the first UE 105-1 for a time period that exceeds a threshold time period. After detecting the period of inactivity associated with the first UE 105-1, the access point 110 may transition the IPSec tunnel to the idle state and may delete the GTP-U tunnel, as described above in connection with FIG. 1B.

As shown at step 2, the access point 110 may be experiencing congestion. For example, the access point 110 may monitor a quantity of connections with the non-3GPP access network provided by the access point. The access point 110 may experience congestion when the quantity of connections with the 3GPP access network exceeds a threshold quantity. In some implementations, the access point 110 may monitor a traffic load on the non-3GPP access network, and may experience congestion when the traffic load exceeds a threshold traffic load.

As shown at step 3, the second UE 105-2 may originate priority session to the first UE 105-1 during the congestion at the access point 110. For example, during the congestion at the access point 110, the second UE 105-2 may initiate a priority session with the first UE 105-1. In some implementations, initiating the priority session may include the second UE 105-2 providing a request for transitioning the IPSec tunnel to an active state and reestablishing the previously deleted GTP-U tunnel with the first UE 105-1. In some implementations, the priority session may be associated with a critical service, such as MPS or MCS. The second UE 105-2 may provide a request for the priority session to the data network, and the data network may provide the request for the priority session to the UPF.

As shown at step 4, the UPF may provide, to the SMF, a session report request requesting permission for the priority session between the second UE 105-2 and the first UE 105-1. For example, based on receiving the request for the priority session from the second UE 105-2, the UPF may generate the session report request that requests permission with the priority session between the second UE 105-2 and the first UE 105-1. The UPF may provide the session report request to the UPF. As further shown at step 4, the SMF may generate a session report response indicating permission for the priority session between the second UE 10-5 and the first UE 105-1. The SMF may provide the session report response to the UPF. For example, the session report response may indicate that the access point 110 is experiencing congestion and that the first UE 105-1 requires a critical service and priority communication.

As shown at step 5, the SMF may provide, the AMF, a message data request requesting data with a fifth-generation (5G) quality of service (QoS) identifier (5QI) for the priority session between the second UE 10-5 and the first UE 105-1. For example, based on receiving the session report request from the UPF, the SMF may generate the message data request that requests data with the 5QI for the priority session between the second UE 10-5 and the first UE 105-1. The SMF may provide the message data request to the AMF. In some implementations, the message data request may include a request for a specific service level agreement (SLA) corresponding to the critical service priority of the first UE 105-1. The specific SLA may ensure that network resources are allocated according to the importance of the service, guaranteeing that critical communications receive the necessary bandwidth and latency requirements. As further shown at step 5, the AMF may generate a message data response indicating that data with the 5QI may be allocated for the priority session between the second UE 105-2 and the first UE 105-1. The AMF may provide the message data response to the SMF.

For example, the message data response may indicate that the AMF will allocate 5QI data for the priority session between the second UE 105-2 and the first UE 105-1.

As shown at step 6, the AMF may provide, to the access point 110, a paging message that includes a paging priority indicator (e.g., information element). For example, based on receiving the message data request requesting 5QI for the priority session, the AMF may generate the paging message that includes the paging prior indicator indicating a priority for the priority session (e.g., a critical service priority). The AMF may provide the paging message with the paging priority indicator to the access point 110. The paging priority indicator may include an urgency level or a critical service flag for the first UE 105-1. The urgency level or service flag may serve as a clear and immediate signal to the access point 110 of the need for expedited handling of the priority session between the first UE 105-1 and the second UE 105-2.

As shown at step 7, the access point 110 (e.g., experiencing congestion) may process the paging message and may identify a priority for the first UE 105-1 based on the paging priority indicator. For example, the access point 110 (e.g., experiencing congestion) may process the paging message and may identify the priority status for the first UE 105-1 based on processing the paging message. In some implementations, the access point 110 may receive a plurality of other paging messages from a plurality of other UEs 105, and may utilize a queue to control prioritization of the plurality of other paging messages based on service criticalities identified in the plurality of other paging messages. The queue may ensure a fair and efficient handling of paging messages and a hierarchy of service delivery during congestion.

As shown at step 8, the access point 110 may provide, to the UPF, a downlink data notification indicating that the access point 110 is experiencing congestion and will treat the first UE 105-1 with a high priority for communications. For example, upon receiving the paging message from the AMF, the access point 110 may generate the downlink data notification indicating that the access point 110 is experiencing congestion and will treat the first UE 105-1 with a high priority for communications. The access point 110 may provide the downlink data notification to the UPF to request expedited handling for the first UE 105-1 based on the critical service priority. The downlink data notification may enable the UPF streamline management of data traffic, giving precedence to critical users and critical data flows.

As shown at step 9, the access point 110 may provide the paging message to the first UE 105-1. For example, the access point 110 may provide the paging message to the first UE 105-1 to notify the first UE 105-1 about the prior session originated by the second UE 105-2. In some implementations, the access point 110 may receive a plurality of paging messages for other UEs 105 in idle states, and may broadcast a general notification paging message to the first UE 105-1 and to the other UEs 105 in idle states. The general notification may enable the first UE 105-1 an the other UEs 105 to check for any pending critical services directed to them.

As shown at step 10, the first UE 105-1 may monitor a paging channel associated with the access point 110, may receive the paging message via the paging channel, and may generate an authorization request (e.g., with the paging priority indicator indicating that the first UE 105-1 is associated with a high priority service) in response to the paging message. For example, the first UE 105-1 may include a paging channel with the access point 110 and may monitor the paging channel associated with the access point 110 even when in an idle state.

Alternatively, the first UE 105-1 may include a dedicated high-priority service channel that is reserved for critical service communications, and may receive the paging message via the high-priority service channel. When the first UE 105-1 receives the paging message, the first UE 105-1 may generate the authorization request that includes the paging priority indicator in response to the paging message.

As shown at step 11, the first UE 105-1 may provide authorization request to the access point 110. For example, the first UE 105-1 may provide authorization request with the paging priority indicator to the access point 110. In some implementations, instead of including the paging priority indicator, the authorization request may include a secure confirmation token that authentically identifies the first UE 105-1 as being associated with a critical service.

As shown at step 12, the access point 110 may treat the first UE 105-1 as critical user with high priority based on the paging priority indicator. For example, upon receipt of the authorization request that includes the paging priority indicator, the access point 110 may acknowledge the first UE 105-1 as a critical user with high priority, thereby granting the first UE 105-1 a favorable status in a communication queue. Alternatively, the access point 110 may identify the first UE 105-1 as a critical user with high priority based on a service type or a subscription level of the first UE 105-1.

As shown at step 13, the first UE 105-1 may be admitted to the priority session with the second UE 105-2 and the IPSec and GTP-U tunnels may be established for the priority session via the access point 110, the AMF, the SMF, and the UPF. For example, the first UE 105-1 may be connected to the priority session with the second UE 105-2 via the IPSec tunnel and the GTP-U tunnel. In some implementations, the access point 110 may utilize the stored context information associated with the IPSec tunnel to transition the IPSec tunnel from the idle state to an active state. The access point 110 may also establish the GTP-U tunnel between the first UE 105-1 and the second UE 105-2. The first UE 105-1 may then be connected to the priority session with the second UE 105-2 via the IPSec tunnel and the GTP-U tunnel.

As shown at step 14, the first UE 105-1 may establish communication with the second UE 105-2. For example, the first UE 105-1 may establish communication with the second UE 105-2 via the IPSec tunnel and the GTP-U tunnel. The first UE 105-1 and the second UE 105-2 may conduct the priority session via the IPSec tunnel and the GTP-U tunnel.

In this way, a non-3GPP access network device (e.g., the access point 110) provides paging priority for a UE 105 associated with a non-3GPP access network. For example, the non-3GPP access network device may intelligently transition a secure tunnel to an idle state in response to detected inactivity from a UE 105. By transitioning the secure tunnel to the idle state after a period of UE inactivity, the non-3GPP access network device may prevent maintaining active but unnecessary connections. The non-3GPP access network device may process a paging message with a priority indicator, and may identify a critical service priority for the UE 105 based on the priority indicator. Upon request from the UE 105, the non-3GPP access network device may promptly transition the secure tunnel from the idle state to an active state to enable communications for the UE 105. Thus, the non-3GPP access network device may conserve computing resources, networking resources, and/or other resources that would have otherwise been consumed by failing to provide critical services when the non-3GPP access network is congested, handling data breaches associated with incorrectly providing critical services when the non-3GPP access is congested, unnecessarily maintaining continuous connections between UEs and the non-3GPP access networks, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

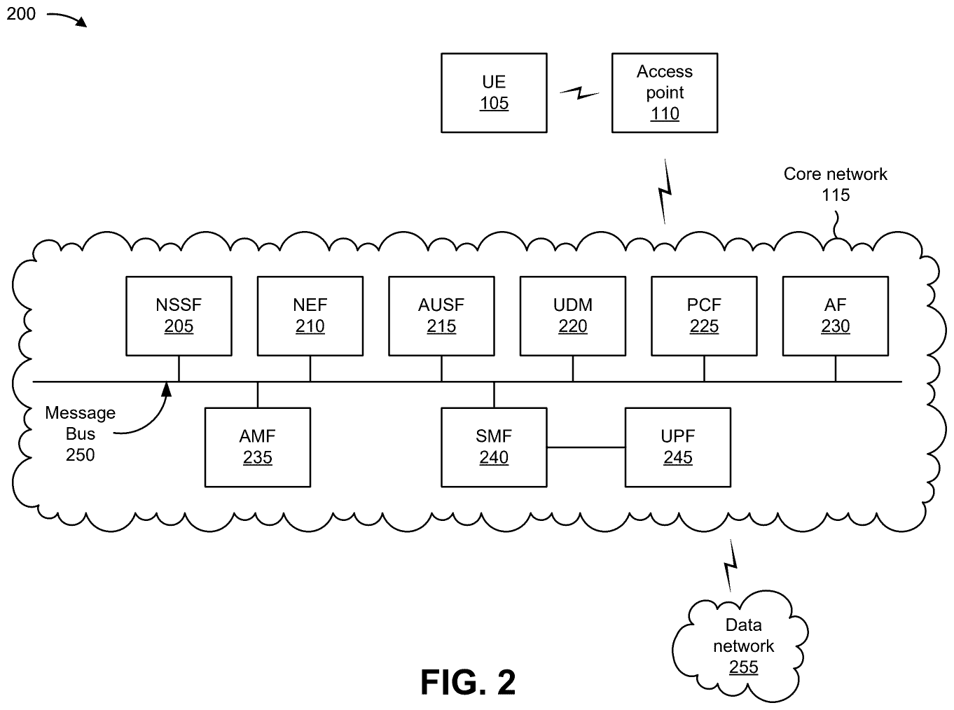

FIG. 2 is a diagram of an example environment 200 in which systems and/or methods described herein may be implemented. As shown in FIG. 2, the example environment 200 may include a UE 105, an access point 110, the core network 115, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The access point 110 may include a network device that allows wireless-capable devices (e.g., the UE 105) to connect to other networks (e.g., a wired network, a wireless network, the core network 115, the data network 255, and/or the like). The access point 110 may generate the non-3GPP access network, which may include a Wi-Fi access network, a fixed access network, a code-division multiple access (CDMA) network, and/or the like. Thus, the access point 110 may include a wireless access point (WAP), a Wi-Fi access network device, a fixed access network device, a CDMA network device, and/or the like.

In some implementations, the core network 115 may include an example functional architecture in which systems and/or methods described herein may be implemented. For example, the core network 115 may include an example architecture of a 5G next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an AMF 235, an SMF 240, and/or a UPF 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

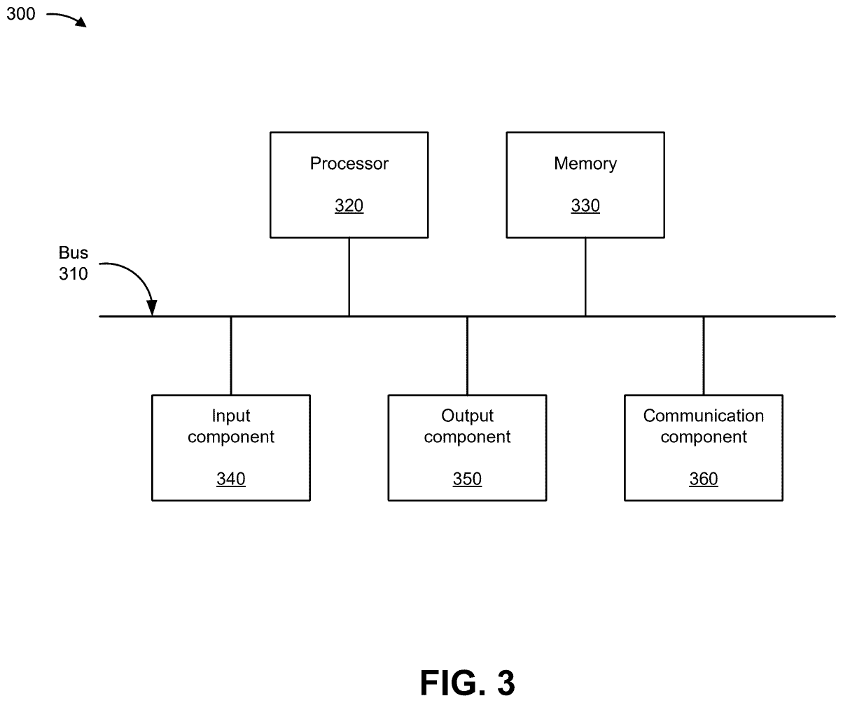

FIG. 3 is a diagram of example components of a device 300, which may correspond to the UE 105, the access point 110, the NSSF 205, the NEF 210, the AUSF 215, the UDM 220, the PCF 225, the AF 230, the AMF 235, the SMF 240, and/or the UPF 245. In some implementations, the UE 105, the access point 110, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

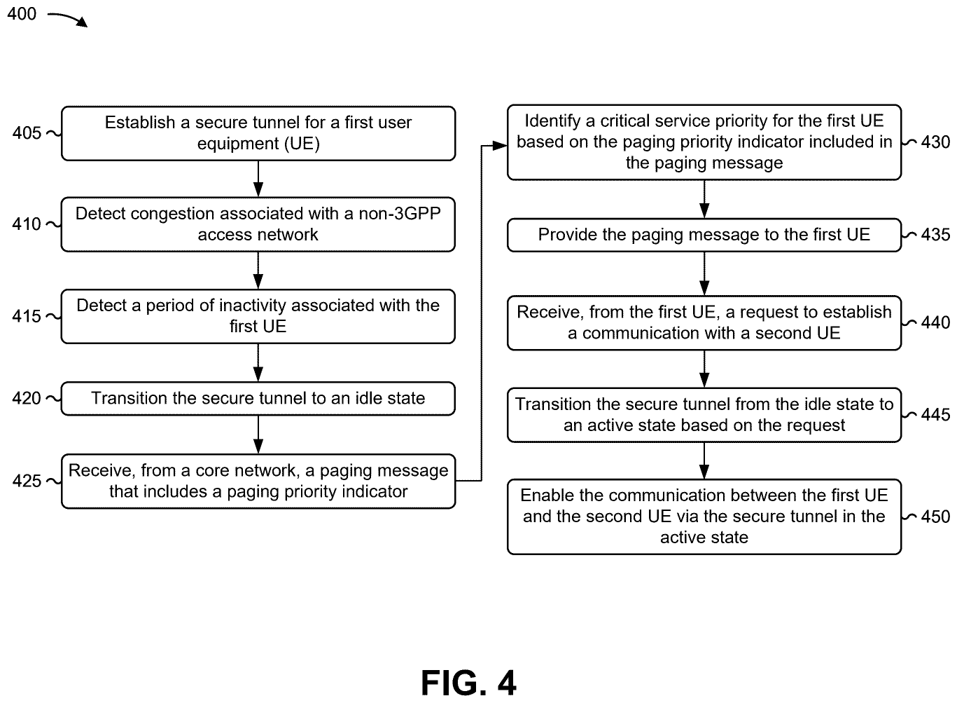

FIG. 4 is a flowchart of an example process 400 for providing paging priority for a UE associated with a non-3GPP access network. In some implementations, one or more process blocks of FIG. 4 may be performed by a network device (e.g., the access point 110). In some implementations, one or more process blocks of FIG. 4 may be performed by another device or a group of devices separate from or including the network device, such as an AMF (e.g., the AMF 235), an SMF (e.g., the SMF 240), and/or a UPF (e.g., the UPF 245). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include establishing a secure tunnel for a first UE (block 405). For example, the network device may establish a secure tunnel for a first UE, as described above. In some implementations, the secure tunnel is an IPSec tunnel.

As further shown in FIG. 4, process 400 may include detecting congestion associated with a non-3GPP access network (block 410). For example, the network device may detect congestion associated with a non-3GPP access network provided by the network device, as described above.

As further shown in FIG. 4, process 400 may include detecting a period of inactivity associated with the first UE (block 415). For example, the network device may detect a period of inactivity associated with the first UE, as described above. In some implementations, detecting the period of inactivity associated with the first UE comprises detecting inactivity of the first UE for a period exceeding a threshold. In some implementations, detecting the period of inactivity associated with the first UE includes monitoring a bearer activity status associated with the first UE, and detecting the period of inactivity associated with the first UE based on monitoring the bearer activity status.

As further shown in FIG. 4, process 400 may include transitioning the secure tunnel to an idle state (block 420). For example, the network device may transition the secure tunnel to an idle state based on detecting the period of inactivity associated with the first UE, as described above.

As further shown in FIG. 4, process 400 may include receiving, from a core network, a paging message that includes a paging priority indicator (block 425). For example, the network device may receive, from a core network, a paging message that includes a paging priority indicator, as described above.

As further shown in FIG. 4, process 400 may include identifying a critical service priority for the first UE based on the paging priority indicator included in the paging message (block 430). For example, the network device may identify a critical service priority for the first UE based on the paging priority indicator included in the paging message, as described above.

In some implementations, the critical service priority for the first UE is associated with a multimedia priority service or a mission-critical service.

As further shown in FIG. 4, process 400 may include providing the paging message to the first UE (block 435). For example, the network device may provide the paging message to the first UE, as described above.

As further shown in FIG. 4, process 400 may include receiving, from the first UE, a request to establish a communication with a second UE (block 440). For example, the network device may receive, from the first UE, a request to establish a communication with a second UE, as described above.

As further shown in FIG. 4, process 400 may include transitioning the secure tunnel from the idle state to an active based on the request (block 445). For example, the network device may transition the secure tunnel from the idle state to an active state based on the request, as described above.

As further shown in FIG. 4, process 400 may include enabling the communication between the first UE and the second UE via the secure tunnel in the active state (block 450). For example, the network device may enable the communication between the first UE and the second UE via the secure tunnel in the active state, as described above.

In some implementations, process 400 includes providing, to the core network, a downlink data notification indicating that the non-3GPP access network is experiencing congestion. In some implementations, process 400 includes establishing a GTP-U tunnel for a first UE. In some implementations, process 400 includes deleting the GTP-U tunnel based on detecting the period of inactivity associated with the first UE. In some implementations, process 400 includes establishing a GTP-U tunnel for a first UE based on the request.

In some implementations, process 400 includes notifying the core network about an idle state of the first UE based on detecting the period of inactivity associated with the first UE. In some implementations, process 400 includes receiving a plurality of other paging messages from a plurality of other UEs, and utilizing a queue to control prioritization of the plurality of other paging messages based on service criticalities identified in the plurality of other paging messages. In some implementations, process 400 includes notifying the core network about the transitioning of the secure tunnel to the idle state. In some implementations, process 400 includes storing context information associated with the secure tunnel after transitioning the secure tunnel to the idle state.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
establishing, by a non-third-generation-partnership-project (non-3GPP) access network device, a secure tunnel for a first user equipment (UE);
detecting, by the non-3GPP access network device, congestion associated with a non-3GPP access network provided by the non-3GPP access network device;
detecting, by the non-3GPP access network device, a period of inactivity associated with the first UE;
transitioning, by the non-3GPP access network device, the secure tunnel to an idle state based on detecting the period of inactivity associated with the first UE;
receiving, by the non-3GPP access network device and from a core network, a paging message that includes a paging priority indicator;
identifying, by the non-3GPP access network device, a critical service priority for the first UE based on the paging priority indicator included in the paging message;
providing, by the non-3GPP access network device, the paging message to the first UE;
receiving, by the non-3GPP access network device and from the first UE, a request to establish a communication with a second UE;
transitioning, by the non-3GPP access network device, the secure tunnel from the idle state to an active state based on the request; and
enabling, by the non-3GPP access network device, the communication between the first UE and the second UE via the secure tunnel in the active state.

2. The method of claim 1, wherein the secure tunnel is an Internet Protocol Security (IPSec) tunnel.

3. The method of claim 1, further comprising:
providing, to the core network, a downlink data notification indicating that the non-3GPP access network is experiencing congestion.

4. The method of claim 1, further comprising:
establishing a general packet radio service tunnelling protocol in user plane (GTP-U) tunnel for a first UE.

5. The method of claim 4, further comprising:
deleting the GTP-U tunnel based on detecting the period of inactivity associated with the first UE.

6. The method of claim 1, further comprising:
establishing a general packet radio service tunnelling protocol in user plane (GTP-U) tunnel for a first UE based on the request.

7. The method of claim 1, wherein detecting the period of inactivity associated with the first UE comprises:
detecting inactivity of the first UE for a period exceeding a threshold.

8. A non-third-generation-partnership-project (non-3GPP) access network device, comprising:
one or more processors configured to:
establish a secure tunnel for a first user equipment (UE),
wherein the secure tunnel is an Internet Protocol Security (IPSec) tunnel;
detect congestion associated with a non-3GPP access network provided by the non-3GPP access network device;
detect a period of inactivity associated with the first UE;
transition the secure tunnel to an idle state based on detecting the period of inactivity associated with the first UE;
receive, from a core network, a paging message that includes a paging priority indicator;
identify a critical service priority for the first UE based on the paging priority indicator included in the paging message;
provide the paging message to the first UE;
receive, from the first UE, a request to establish a communication with a second UE;
transition the secure tunnel from the idle state to an active state based on the request; and
enable the communication between the first UE and the second UE via the secure tunnel in the active state.

9. The non-3GPP access network device of claim 8, wherein the one or more processors are further configured to:
notify the core network about an idle state of the first UE based on detecting the period of inactivity associated with the first UE.

10. The non-3GPP access network device of claim 8, wherein the critical service priority for the first UE is associated with a multimedia priority service or a mission-critical service.

11. The non-3GPP access network device of claim 8, wherein the one or more processors are further configured to:
receive a plurality of other paging messages from a plurality of other UEs; and
utilize a queue to control prioritization of the plurality of other paging messages based on service criticalities identified in the plurality of other paging messages.

12. The non-3GPP access network device of claim 8, wherein the one or more processors are further configured to:
notify the core network about the transitioning of the secure tunnel to the idle state.

13. The non-3GPP access network device of claim 8, wherein the one or more processors, to detect the period of inactivity associated with the first UE, are configured to:
monitor a bearer activity status associated with the first UE; and
detect the period of inactivity associated with the first UE based on monitoring the bearer activity status.

14. The non-3GPP access network device of claim 8, wherein the one or more processors are further configured to:
store context information associated with the secure tunnel after transitioning the secure tunnel to the idle state.

15. A non-transitory computer-readable medium storing a set of instructions, the set of instructions comprising:
one or more instructions that, when executed by one or more processors of a non-third-generation-partnership-project (non-3GPP) access network device, cause the non-3GPP access network device to:
establish a secure tunnel for a first user equipment (UE);
detect congestion associated with a non-3GPP access network provided by the non-3GPP access network device;
provide, to a core network, a downlink data notification indicating that the non-3GPP access network is experiencing congestion;
detect a period of inactivity associated with the first UE;
transition the secure tunnel to an idle state based on detecting the period of inactivity associated with the first UE;
receive, from the core network, a paging message that includes a paging priority indicator;
identify a critical service priority for the first UE based on the paging priority indicator included in the paging message;
provide the paging message to the first UE;
receive, from the first UE, a request to establish a communication with a second UE;
transition the secure tunnel from the idle state to an active state based on the request; and
enable the communication between the first UE and the second UE via the secure tunnel in the active state.

16. The non-transitory computer-readable medium of claim 15, wherein the one or more instructions further cause the non-3GPP access network device to:
establish a general packet radio service tunnelling protocol in user plane (GTP-U) tunnel for a first UE based on the request.

17. The non-transitory computer-readable medium of claim 15, wherein the one or more instructions, that cause the non-3GPP access network device to detect the period of inactivity associated with the first UE, cause the non-3GPP access network device to:
detect inactivity of the first UE for a period exceeding a threshold.

18. The non-transitory computer-readable medium of claim 15, wherein the one or more instructions further cause the non-3GPP access network device to:
notify the core network about an idle state of the first UE based on detecting the period of inactivity associated with the first UE.

19. The non-transitory computer-readable medium of claim 15, wherein the one or more instructions further cause the non-3GPP access network device to:
receive a plurality of other paging messages from a plurality of other UEs; and
utilize a queue to control prioritization of the plurality of other paging messages based on service criticalities identified in the plurality of other paging messages.

20. The non-transitory computer-readable medium of claim 15, wherein the one or more instructions, that cause the non-3GPP access network device to detect the period of inactivity associated with the first UE, cause the non-3GPP access network device to:
monitor a bearer activity status associated with the first UE; and
detect the period of inactivity associated with the first UE based on monitoring the bearer activity status.
